(19) United States
(12) Patent Application Publication
(10) Pub. No.: US 2007/0030789 A1
(43) Pub. Date: Feb. 8, 2007

(54) Method and radiation source driving device for controlling radiation power

(76) Inventor: James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,631

(22) PCT Filed: May 13, 2004
(86) PCT No.: PCT/IB04/50677

§ 371 Date: Nov. 17, 2005

(30) Foreign Application Priority Data
May 20, 2003 (EP) 03101425.1

(51) Int. Cl. G11B 7/00

(52) U.S. Cl. 369/116

(57) ABSTRACT

The invention pertains to a method off controlling radiation power of a radiation source (25) comprising the steps of a) measuring a radiated power of the radiation source (25), b) calculating an error value (e) which is indicative of a difference between the 5 radiated power and a setpoint value (SP), c) integrating the error value (e) to obtain an integrated error value by feeding the error value to an integrator (21), d) multiplying the error value (e) with a factor p to obtain a proportional error value, driving the radiation source (25) with a current which is derived from the error value (e) by adding the integrated error value and the proportional error value, f) providing a step signal (St) which indicates that the setpoint value (SP) is changed stepwise, and g) temporarily stopping the integration of the error value (e) when the step signal (St) indicates a stepwise change in the setpoint value (SP). By temporarily stopping the integrator (21) from integrating the integrator (21) does not wind up. Only the proportional value is used to drive the radiation source (25). This ensures that the radiation power is controlled fast to a value near the setpoint value (SP). When the integrator (21) is allowed to integrate again, then the error value (e) is reduced further. Also, the overshoot is reduced.

The invention pertains to a method of controlling radiation power of a radiation source comprising the steps of

a) measuring a radiated power of the radiation source,

b) calculating an error value which is indicative of a difference between the radiated power and a setpoint value,

c) integrating the error value to obtain an integrated error value by feeding the error value to an integrator,

d) multiplying the error value with a factor p to obtain a proportional error value, and

e) driving the radiation source with a current which is derived from the error value by adding the integrated error value and the proportional error value.

The invention also pertains to a radiation source driving device for controlling a radiation power of a radiation source in an information reproducing and/or recording system for reproducing and/or recording information from/to an information carrier, comprising

radiation power measurement means for measuring a radiation power of the radiation source,

error value calculation means for determining an error value by calculating a difference between the measured radiation power and a setpoint value,

integration means for determining an integrated error value by integrating the error value,

multiplying means for determining a proportional error value by multiplying the error value with a factor p,

adding means for determining a PI error value by adding the integrated error value and the proportional error value,

radiation source current generator for feeding a current to the radiation source wherein the current is dependent on the PI error value.

The invention further pertains to an information reproducing and/or recording device for reproducing and/or recording information from/to an information carrier comprising the radiation source driving device.

An example of an information reproducing and/or recording device is the DVD+RW recorder, but also other information reproducing and/or recording devices are suitable for implementing the current invention. In the DVD+RW recorder a radiation source is present in the form of a semiconductor laser. The laser is controlled by a laser controller. The laser controller controls the current to the laser such that the radiation intensity is set to a certain level. To be able to accurately control that level, the outputted radiation intensity is measured. The measured radiation intensity is subtracted from a setpoint value to obtain an error signal. The error signal is used to control the laser current. In order to keep the error signal as low as possible the control circuit comprises an integrator. The integrator has the effect that low frequency components in the error signal are suppressed. From EP 0385537 a laser control circuit is known. This laser control circuit comprises a sensor for measuring the outputted radiation intensity. The measured radiation intensity is subtracted from a setpoint value and subsequently fed to an integrator.

The feedback of the measured radiation intensity takes some time and therefore has a certain lag time. Consequently, when the setpoint value is changed stepwise, then the error signal also changes stepwise. This has the consequence that the integrator winds up, meaning that the output of the integrator increases while it takes a long time afterwards to decrease the output. Therefore, the outputted radiation of the radiation source reacts slowly to the setpoint increase and will have an overshoot.

It is a purpose of the invention to provide a method of controlling radiation power of a radiation, source which is able to control the radiation power faster to the desired value after a stepwise change in setpoint, and with less overshoot. It is a further purpose to provide a radiation source driving device which is capable of controlling the radiation power faster to the desired value after a stepwise change in setpoint, and with less overshoot. It is also a purpose to provide an information reproducing and/or recording device comprising such a radiation source driving device.

According to the invention the method further comprises the steps of

f) providing a step signal which indicates that the setpoint value is changed stepwise, and

g) temporarily stopping the integration of the error value when the step signal indicates a stepwise change in the setpoint value.

This keeps the integrator from winding up. Only the proportional error value is used to drive the radiation source. This ensures that the radiation power is controlled fast to a value near the setpoint value. When the integrator is allowed to integrate the error value again, then the error value is further reduced. Also, the overshoot is reduced.

The moment when the integration is started again can be accomplished by just waiting a certain amount of time. In a further embodiment of the invention the integration of the error value in step g is stopped until the error value becomes smaller than a threshold value. This has the advantage that a clearly defined moment is used to start integrating again. When the error value is relatively low, then the integration can be started again without the danger of winding up.

In a further embodiment of the method according to the invention the method further comprises a step of resetting the integrator after the step signal indicates a stepwise change in the setpoint value. An integrator has a certain memory function. It sums (integrates) the previous error values. Before a stepwise change in the setpoint value is initiated, the sum in the integrator can be large. This sum has no relation with the new setpoint value, and the sum should therefore be reset. Then, when the integrator starts integrating again, the integration process starts at a good initial value again.

The integration of the error value can be stopped by disconnecting the error value from the integrator. This can be accomplished for instance with a switch between the error value and the integrator. Additionally, the input of the integrator can be connected to a signal having a zero value.

According to the invention the radiation source driving device further comprises blocking means for temporarily stopping the integration means from integrating the error value in response to a step signal indicating a stepwise change in the setpoint value.

In a further embodiment of the radiation source driving device the blocking means comprise switching means for connecting and disconnecting the error value to the integration means and wherein the blocking means stop the integration means from integrating the error value by disconnecting the error value from the integration means by controlling the switching means.

In a still further embodiment of the radiation source driving device the blocking means are arranged to stop the integration means from integrating the error value until the error value is smaller than a threshold value.

When writing information to the information carrier, the radiation power of the radiation source must be higher compared to the situation when information is only read from the information carrier. Therefore, in a further embodiment of the radiation source driving device a first value of the step signal indicates that the information is reproduced from the information carrier and a second value of the step signal indicates that the information is recorded to the information carrier.

In a further embodiment of the radiation driving device the integration means are reset in response to the step signal.

In accordance with the invention the information reproducing and/or recording device for reproducing and/or recording information from/to an information carrier comprising

a radiation source driving device according to the invention,

a radiation source for generating a radiation beam, which radiation source is driven by the radiation source driving device,

means for mapping the radiation beam at a spot on the information carrier, and

means for causing a relative displacement between the spot and the information carrier.

These and other aspects of the invention are described in more detail with reference to the figures. Therein

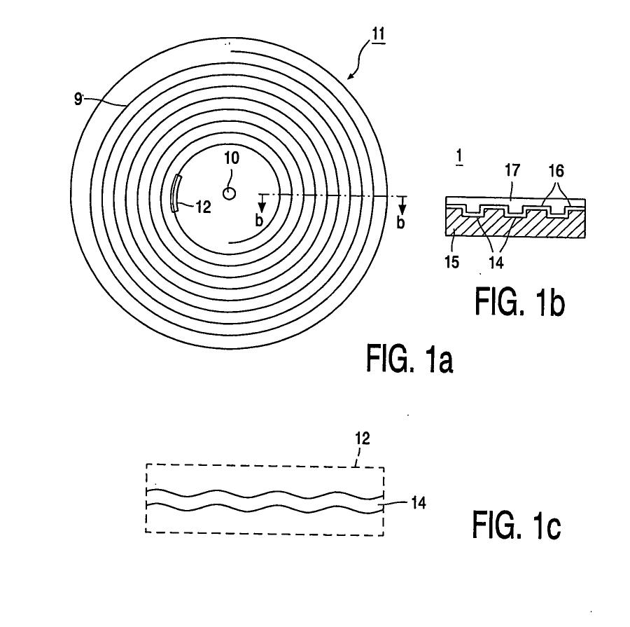

FIG. 1a shows a disc shaped information carrier,

FIG. 1b shows a cross-section taken of the information carrier,

FIG. 1c shows an example of a wobble of the track,

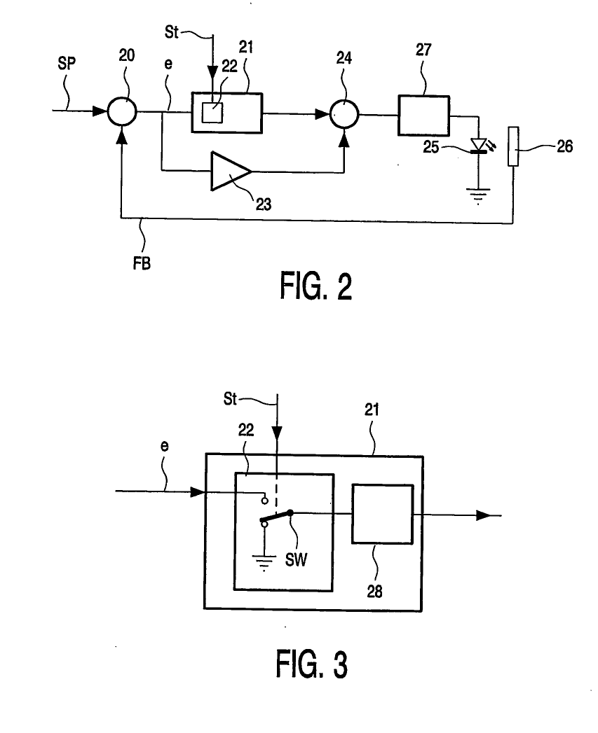

FIG. 2 shows an embodiment of a radiation source driving device according to the invention,

FIG. 3 shows an embodiment of the blocking means,

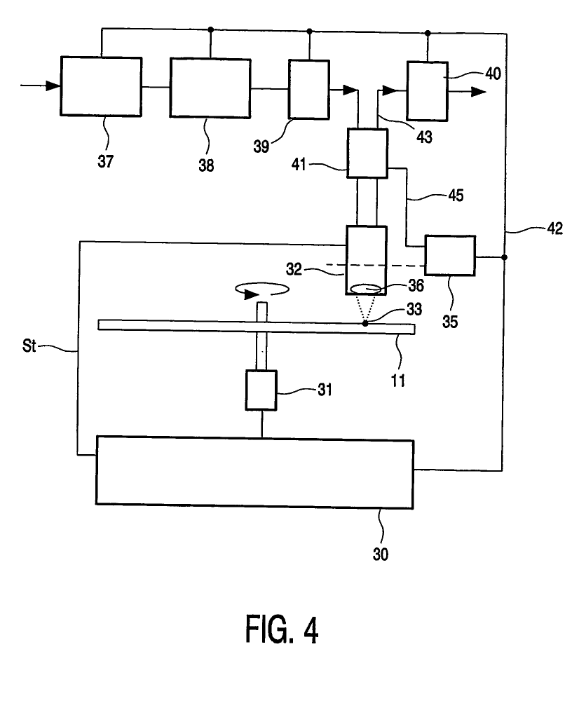

FIG. 4 shows an embodiment of an information reproducing and/or recording device according to the invention,

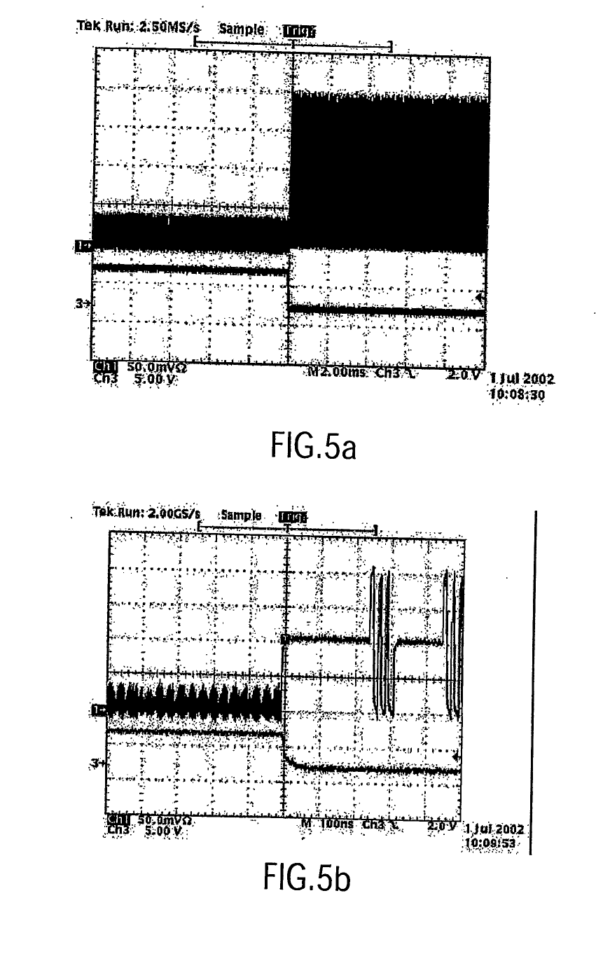

FIG. 5a shows a graph representing the transition of measured radiation power when switching from read mode to write mode, and

FIG. 5b shows a magnified part of the graph in FIG. 5a

FIG. 1a shows a disc-shaped information carrier 11 having a track 9 and a central hole 10. The track 9 is arranged in accordance with a spiral pattern of turns constituting substantially parallel tracks on an information layer. The information carrier may be an optical disc having an information layer of a recordable type. Examples of a recordable disc are the CD-R, CD-RW and the DVD+RW. The track 9 on the recordable type of information carrier is indicated by a pre-embossed track 9 structure provided during manufacture of the blank information carrier, for example a pregroove. Recorded information is represented on the information layer by optically detectable marks recorded along the track 9. The marks are constituted by variations of a physical parameter and thereby have different optical properties than their surroundings, e.g. variation in reflection.

FIG. 1b is a cross-section taken along the line b-b of the information carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

In an embodiment the information carrier 11 is carrying information representing digitally encoded video according to a standardized format like MPEG2.

FIG. 1c shows an example of a wobble of the track 9. A detail 12 of the track 9 shows a periodic variation of the lateral position of the pregroove 14, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the wobble and encoding information therein can be found for CD in U.S. Pat. No. 4,901,300 (PHN 12.398) and U.S. Pat. No. 5,187,699 (PHQ 88.002), and for the DVD+RW system in U.S. Pat. No. 6,538,982 (PHN 17.323).

The schematic diagram of the radiation source driving device in FIG. 2 will be used to further elucidate the invention. The error value calculation means 20 subtracts the measured radiation power FB from the setpoint value SP resulting in an error value e. The multiplying means 23 multiply the error value e with a factor p. The integration means 21 integrate the error value to obtain the integrated error value. The proportional error value and the integrated error value are added by the adding means 24 to obtain the PI error value. The PI error value is fed to the radiation source current generator 27 which generates a current which is dependent on the PI error value. The generated current is fed to the radiation source 25. The radiation source 25 emits radiation as a consequence of the current fed to the radiation source 25. The emitted radiation is measured by the radiation power measurement means 26. According to the invention the radiation source driving device further comprises blocking means 22 for stopping the integration means from integrating the error value e in response to a step signal St indicating a stepwise change in the setpoint value SP. In FIG. 2 the blocking means 22 are incorporated in the integration means 21. However, the invention is not limited to this embodiment. The blocking means 22 can for instance also be placed in front of the integration means 21. Important is that the blocking means 22 can perform the function of stopping the integration means 21 from integrating the error value, the position of the blocking means 22 is not relevant for the invention.

As is shown in FIG. 3 the blocking means can comprise switching means SW. The switching means SW are controlled by the step signal St. In normal operation the switching means connect the error value e to the integrator 28. When the step signal St indicates that the setpoint value SP is changed stepwise, then the switching means SW connect the input of the integrator 28 to a zero value (indicated in FIG. 3 by the mass symbol). This results in that the integrator 28 does not integrate the error value e anymore. The output of the integrator 28 does not change during the time that the switching means connect the zero value to the input of the integrator 28. When the setpoint value SP is changed stepwise, the error value e also changes stepwise. The integration means 21 starts integrating the error value e. The integration means 22 comprise a memory which is used to store a value representing the sum of previous error values. The multiplying means 23 directly react to the error value resulting in a direct change of the PI error value. Consequently the radiation source current generator 27 generates a changed current directly. The radiation power measurement means 26 measure the change radiation power of the radiation source 25. However, it takes some time to measure the radiation power and convert is to a signal representing the radiation power. The feedback signal FB thus suffers from a certain lag. The error value e therefore does not represent the real error between the setpoint value SP and the radiation power emitted by the radiation source 25 during the lag period. The inventors have had this insight and found a solution in temporarily stopping the integration means 21 from integrating the error value e when the setpoint value SP changes stepwise. A stepwise change means a change of the setpoint value SP which is too fast for the radiation power measurement means 26 to follow, i.e. the feedback signal FB does not represent the real emitted radiation power of the radiation source 25.

If the integrating means 21 are implemented in firmware, i.e. the integration function is performed in software, then the integration means 21 can be stopped by just setting a parameter to zero. In software the integration is performed by adding the current error value to a total sum of previous error values. During the time the integration means have to be stopped, the current error value can be set to zero. Other implementations of stopping the integration means 21 from integrating are also possible without departing from the invention.

FIG. 4 shows an information reproducing and/or recording device according to the invention. The device includes rotating means 31 for rotating the information carrier 11, a head 32, a servo unit 35 for positioning the head 32 on the track 9, and a control unit 30. The head includes the radiation source driving device, the radiation source 25, and means 36 for mapping the radiation emitted by the radiation source 25 at a spot 33 at the information carrier 11. The radiation source 25 can be a laser diode. The means 36 can be an optical system of a known type for guiding the radiation beam through optical elements and focus the radiation beam to a radiation spot 33 on a track 9 of the information carrier 11. The head further comprises (not shown) a focusing actuator for moving the focus of the radiation beam along the optical axis of said beam and a tracking actuator for fine positioning of the spot 33 in a radial direction on the center of the track 9. The tracking actuator may comprise coils for radially moving an optical element or may alternatively be arranged for changing the angle of a reflecting element. The focusing and tracking actuators are driven by actuator signals from the servo unit 35. For reading the radiation reflected by the information carrier 11 is detected by a detector of a usual type, e.g. a four-quadrant diode, in the head 32 for generating detector signals coupled to a front-end unit 41 for generating various scanning signals, including a main scanning signal 43 and error signals 45 for tracking and focusing. The error signals 45 are coupled to the servo unit 35 for controlling said tracking and focusing actuators. The main scanning signal 43 is processed by read processing unit 40 of a usual type including a demodulator, deformatter and output unit to retrieve the information.

In an embodiment the device is provided with recording means for recording information on an information carrier 11 or a writable or re-writeable type, for example CR-R or CD-RW, or DVD+RW or BD. The recording means cooperate with the head 32 and front-end unit 41 for generating a write beam of radiation, and comprise write processing means for processing the input information to generate a write signal to drive the head 32, which write processing means comprise an input unit 37, a formatter 38 and a modulator 39. For writing information the beam of radiation is controlled to create optically detectable marks on the information carrier 11. The marks may be in any optically readable form, e.g. in the form of areas with a reflection coefficient different from their surroundings, obtained when recording in materials such as dye, alloy or phase change material. or in the form of areas with a direction of polarization different from their surroundings. obtained when recording in magneto-optical material.

Writing and reading of information for recording on optical disks and formatting, error correcting and channel coding rules are well-known in the art, e.g. from the CD or DVD system. In an embodiment the input unit 37 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The control unit 30 controls the scanning and retrieving of information and may be arranged for receiving commands form a user of from a host computer. The control unit 30 is connected via control lines 42, e.g. a system bus, to the other units in the device. The control unit 30 may also generate the setpoint value SP. When a stepwise change of the setpoint value SP is introduced the control unit 30 generates a step signal St. The step signal is fed to the head 32 and more specifically to the radiation source driving device. For instance, when the information reproducing and/or recording device-switches from read to write mode, the setpoint value increases substantially. The step signal St can in that case be a digital signal indicating if the information reproducing and/or recording device is in read or in write mode.

From FIG. 5a the transition from read to write mode can be seen when using the radiation source driving device according to the invention. The transition is very fast and the overshoot is minimal. In FIG. 5b the transition is depicted with a smaller time scale. Clearly, there is no overshoot and the transition is performed in a minimal amount of time.

1. Method of controlling radiation power of a radiation source (25) comprising the steps of
a) measuring a radiated power of the radiation source (25),
b) calculating an error value (e) which is indicative of a difference between the radiated power and a setpoint value (SP),
c) integrating the error value (e) to obtain an integrated error value by feeding the error value to an integrator (21),
d) multiplying the error value (e) with a factor p to obtain a proportional error value, and
e) driving the radiation source (25) with a current which is derived from the error value (e) by adding the integrated error value and the proportional error value,
characterized in that method further comprises the steps of
f) providing a step signal (St) which indicates that the setpoint value (SP) is changed stepwise, and
g) temporarily stopping the integration of the error value (e) when the step signal (St) indicates a stepwise change in the setpoint value (SP).

2. Method as claimed in claim 1, characterized in that the integration of the error value (e) in step g is stopped until the error value (e) becomes smaller than a threshold value.

3. Method as claimed in claim 1, characterized in that the method further comprises a step of resetting the integrator (21) after the step signal (St) indicates a stepwise change in the setpoint value (SP).

4. Method as claimed in claim 1, characterized in that the integration of the error value (e) in step g is stopped by disconnecting the error value (e) from the integrator (21).

5. A radiation source driving device for controlling a radiation power of a radiation source (25) in an information reproducing and/or recording system for reproducing and/or recording information from/to an information carrier (11), comprising
radiation power measurement means (26) for measuring a radiation power of the radiation source (25),
error value calculation means (20) for determining an error value (e) by calculating a difference between the measured radiation power (FB) and a setpoint value (SP),
integration means (21) for determining an integrated error value by integrating the error value (e),
multiplying means (23) for determining a proportional error value by multiplying the error value (e) with a factor p,
adding means (24) for determining a PI error value by adding the integrated error value and the proportional error value,
radiation source current generator (27) for feeding a current to the radiation source (25) wherein the current is dependent on the PI error value,
characterized by blocking means (22) for temporarily stopping the integration means (21) from integrating the error value (e) in response to a step signal (St) indicating a stepwise change in the setpoint value (SP).

6. A radiation source driving device as claimed in claim 5, characterized in that the blocking means (22) comprise switching means (SW) for connecting and disconnecting the error value (e) to the integration means (21) and wherein the blocking means (22) stop the integration means (21) from integrating the error value (e) by disconnecting the error value (e) from the integration means (21) by controlling the switching means (SW).

7. A radiation source driving device as claimed in claim 5, characterized in that the blocking means (22) are arranged to stop the integration means (21) from integrating the error value (e) until the error value (e) is smaller than a threshold value.

8. A radiation source driving device as claimed in claim 5, characterized in that a first value of the step signal (St) indicates that information is reproduced from the information carrier (11) and a second value of the step signal (St) indicates that information is recorded to the information carrier (11).

9. A radiation source driving device as claimed in claim 5, characterized in that the integration means (21) are reset in response to the step signal (St).

10. Information reproducing and/or recording device for reproducing and/or recording information from/to an information carrier (11) comprising
a radiation source driving device as claimed in claim 5,
a radiation source (25) for generating a radiation beam, which radiation source (25) is driven by the radiation source driving device,
means (36) for mapping the radiation beam at a spot (33) on the information carrier (11), and
means (31) for causing a relative displacement between the spot (33) and the information carrier (11).
